(19) United States
(12) Patent Application Publication
(10) Pub. No.: US 2013/0253723 A1
(43) Pub. Date: Sep. 26, 2013

(54) METHOD FOR LOAD CONTROL IN A LOAD CONTROL DEVICE

(71) Applicants: Jung Hwan Oh, Seoul (KR); Jae Seong Park, Daejeon Metropolitan City (KR); Se Young Lee, Anyang-si (KR)

(72) Inventors: Jung Hwan Oh, Seoul (KR); Jae Seong Park, Daejeon Metropolitan City (KR); Se Young Lee, Anyang-si (KR)

(73) Assignee: LSIS CO., LTD., Anyang-si, Gyeonggi-do (KR)

(21) Appl. No.: 13/992,687

(22) PCT Filed: Nov. 25, 2011
(86) PCT No.: PCT/KR2011/009050

§ 371 Date: Jun. 7, 2013

(30) Foreign Application Priority Data
Dec. 9, 2010 (KR) 10-2010-0125787

(51) Int. Cl. G06F 1/26

(52) U.S. Cl. CPC G06F 1/26
USPC 700/295

(57) ABSTRACT

A method for load control in a load control device is disclosed. According to the method for load control of the present invention, a user intuitively recognizes the economic gain of a load control command in order to consider the efficiency of the load control system.

### TECHNICAL FIELD

The present invention relates to a load control method for load control apparatus, and more particularly to a load control method for load control apparatus configured to effectively perform a power management function to load devices in a customer location.

### BACKGROUND ART

Electric power consumption is on the rise in various fields. Particularly, occasions may arise where electric power consumption momentarily increases per season and per region to create a problem to electric power demand in social infrastructure that must be essentially maintained. In hot summer days particularly, phenomenon often occurs where the electric demand temporarily surges due to sudden increase in use of air conditioners.

In a case the electric power consumption surpasses useable supply capacity; power grid may suffer from fatal damages regardless of locations such as power consumption region and power consumption facility. Thus, in a case the power consumption surpasses the supply capacity, power supply supplied to all users may be automatically and indiscriminately interrupted in order to prevent the power grid from being damaged, or a black-out, a large scale power supply interruption, may occur where power supply is temporarily stopped to a selected area.

Therefore, there is a need to adequately adjust the power consumption at a user side in order to prevent the black-out from occurring.

### DISCLOSURE

### Technical Problem

The present invention is provided to solve the aforementioned problems and the present invention provides a load control method for load control apparatus configured to provide a load control message for controlling a power load, whereby power load on load devices in a customer location can be effectively controller.

### Technical Solution

In one general aspect of the present disclosure, there may be provided a load control method for load control apparatus, the method comprising: receiving, from a host device, a load control message comprising a condition to be performed by load control and price-based information; determining whether the load control message satisfies a preset condition; transmitting a load control command to at least one load device based on the load control message when the load control message satisfies the preset load control condition; and transmitting a response message comprising information indicating load control state to the host device or an outside device in response to the load control message.

In some exemplary embodiments of the present disclosure, the method may further comprise transmitting the load control message to a display device; and performing a load control of at least one load device in response to the load control command when the load control command is received from a user.

In some exemplary embodiments of the present disclosure, the display device may be included in the load control apparatus or the load device.

In some exemplary embodiments of the present disclosure, the display device may include a mobile device.

In some exemplary embodiments of the present disclosure, the price-based information may include information indicating a saved energy rate or a rate level corresponding to saved rate when the load control is performed.

In some exemplary embodiments of the present disclosure, the preset load control condition may comprise at least one of price-based information during load control and time information for load control.

In some exemplary embodiments of the present disclosure, the method may further comprise receiving from the load device a request message for load activation; and transmitting to the load device a response message indicating whether to approve of the load activation request message based on at least one of the load control message and the preset load control condition.

In another general aspect of the present disclosure, there may be provided a load control method for load control apparatus, the method comprising: receiving, from a host device, a load control message including dynamic rate information related to time; determining whether the load control message satisfies the preset load control condition; transmitting a load control command to at least one load device based on the load control message when the load control message satisfies the preset load control condition; and transmitting a response message including information indicating load control state to the host device or an outside device in response to the load control message.

In some exemplary embodiments of the present disclosure, the method may further comprise transmitting the load control message to a display device, and performing the load control of devices in a consumer house in response to the load control command when the load control message is received from a user.

In some exemplary embodiments of the present disclosure, the dynamic rate information may include information indicating any one of TOU (Time of Use), CPP (Critical Peak Pricing), CPR (Critical Peak Rebate) and RTP (Real Time Pricing).

In some exemplary embodiments of the present disclosure, the preset load control condition may include at least one of a save amount during load control and time information for load control.

In some exemplary embodiments of the present disclosure, the method may further comprise receiving, from a device in a consumer house, a request message for load activation; and transmitting to, the device in the consumer house, a response message indicating whether to approve of the load activation request message based on at least one of the load control message and a user load control condition.

### Advantageous Effects

The load control method for load control apparatus according to the exemplary embodiments of the present disclosure has an advantageous effect in that a user can institutively recognize a gain of load control command to enhance efficiency of a load control system, and a user participation can be more easily induced by notifying money-wise a user information on load control on the position of utility. Another advantageous effect is that a billing to load control can be eased from the position of utility, a user can be made to recognize an automatic cancellation of load control command, a power charge can be actively saved by allowing a user to perform a load control in response to price information.

### DESCRIPTION OF DRAWINGS

FIG. 1 is a block diagram illustrating a system for power load control according to an exemplary embodiment of the present disclosure.

FIG. 2 is a flowchart illustrating a load control method according to an exemplary embodiment of the present disclosure.

FIG. 3 is a schematic view illustrating a field configuration of a load control message according to an exemplary embodiment of the present disclosure.

### BEST MODE

Advantages and features of the present disclosure may be understood more readily by reference to the following detailed description of exemplary embodiments and the accompanying drawings. Detailed descriptions of well-known functions, configurations or constructions are omitted for brevity and clarity so as not to obscure the description of the present disclosure with unnecessary detail.

Hereinafter, the load control method for load control apparatus according to exemplary embodiments will be described more fully hereinafter with reference to the accompanying drawings.

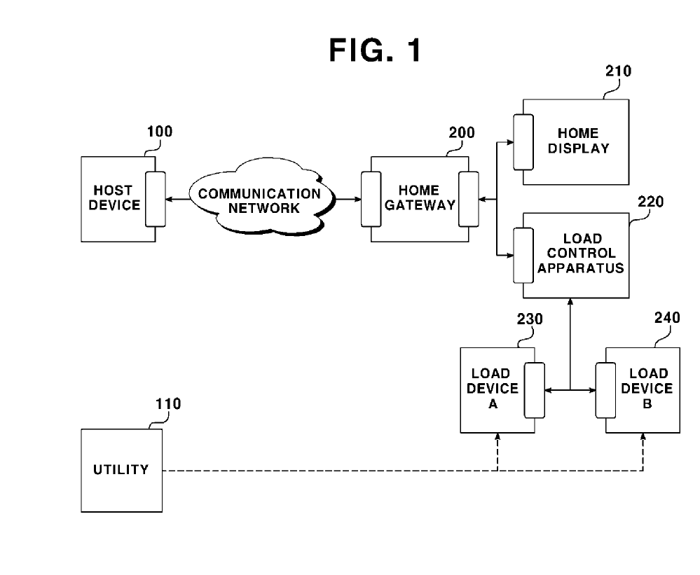

FIG. 1 is a block diagram illustrating a system for power load control according to an exemplary embodiment of the present disclosure. Referring to FIG. 1, a power load control system according to an exemplary embodiment of the present disclosure includes a host device 100, a load control apparatus 220 and a home display 210. The host device 100 and the load control apparatus 220 may be connected to a wireless or wired communication network through a home gateway 200, and the home gateway 200 may be integrated with function of the load control apparatus 220.

The home display 210, the load control apparatus 220, and the home display 210 may be connected to a wired or wireless communication network via the home gateway 200.

The host device 100 may be a load control server mounted at a utility 100 or management and service provider side supplying a power as an outside device to control a power load. The host device 100 may be a device formed with a typical hardware or software performing a hose process, and may classify a power load to various regions.

The hose device 100 may be mounted with a database including addresses of extensive regions other necessary information for collecting and managing power load related information of a relevant region. Furthermore, the host process of the host device 100 may control a power load relative to an entire region supplying power, and may include other functions for controlling the power load.

The host device 100 and the home gateway 200 are connected to a communication network such as Internet. The communication network may be generally a super highway communication network. Furthermore, although the home gateway 200 can mutually connect or relay subscriber access network, the home gateway 200 may be performed as a home server having various server functions configured to provide multimedia functions by adding middleware to upper layer. Furthermore, in another exemplary embodiment, the home gateway 200 may perform only a gateway function for communicating with an outside communication network, and the load control apparatus 220 may be realized to operate as a home server.

Meantime, load devices A and B (230 and 240) may be various devices consuming an electric power such as refrigerators, heaters and display devices actually consuming the power inside a house or an office. That is, the load devices A and B (230 and 240) may include most of devices consuming the power inside a consumer house.

The load devices A and B (230 and 240) may be connected to an IHD (In-Home Display) or the load control apparatus 220.

In another exemplary embodiment, each of the load devices A and B (230 and 240) may be separately connected with the home display 210 and the load control apparatus 220.

Now, the load control method for load control apparatus according to exemplary embodiments of the present disclosure thus configured will be described.

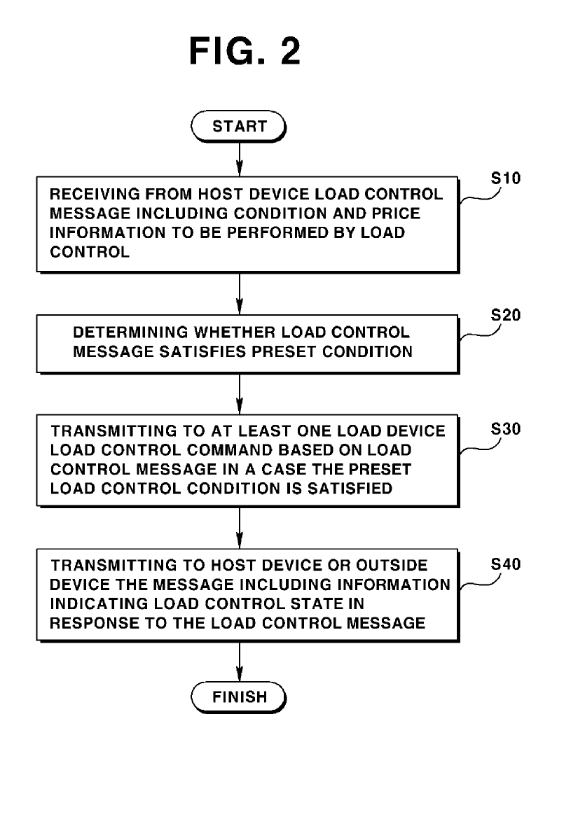

FIG. 2 is a flowchart illustrating a load control method according to an exemplary embodiment of the present disclosure. Referring to FIG. 2, the power load control method according to exemplary embodiment of the present disclosure includes performing a step (S10) receiving, from the host device, a load control message including a condition to be performed by the load control and price-based information.

Now, the load control message will be described in more detail.

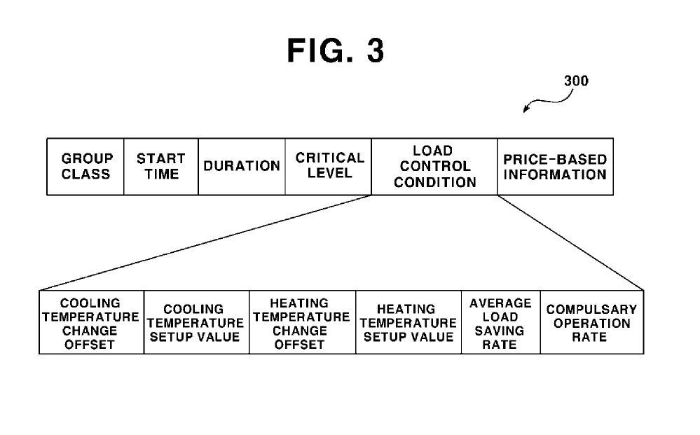

FIG. 3 is a schematic view illustrating a field configuration of a load control message 300 according to an exemplary embodiment of the present disclosure. Referring to FIG. 3, the load control message 300 includes a type of particular group or a group class configured to identify the type of particular group, a start time for starting performance of load control, a duration indicating a performance period of the load control, a critical level indicating urgency of the load control, a load control condition indicating condition for load control, and price-based information obtained during execution of the load control.

The load control condition may include control information for controlling a total load of load devices controlled by the load control apparatus. For example, the load control condition may include information adjusting a total load of the load control apparatus relative to a based total load in percentage. Furthermore, the load control condition may selectively include information for controlling a connection (ON) time section of a part or a total of a load device controlled by the load control apparatus, a disconnection (OFF) time section, a repetitive cycle, and information for controlling operations subsequent to a predetermined time after receipt of a message.

Furthermore, the load control condition may selectively include various items for detailed load control (e.g., cooling temperature offset, cooling temperature set-up point, a heating temperature offset, a heating temperature set-up point), an average load adjustment percentage and a duty cycle.

The price-based information may include information indicating an energy rate saved when a load control inside the load control message is performed, or a rate level corresponding to saving rate. Furthermore, the price-based information may include dynamic rate information that changes in time, where the dynamic rate information may include information indicating any one of TOU (Time of Use), CPP (Critical Peak Pricing), CPR (Critical Peak Rebate) and RTP (Real Time Pricing).

The critical level indicating urgency of the load control may include various levels. For example, the critical level may include several levels each having low urgency, an emergency level indicating urgency, an outage level indicating an anticipated outage and a forced outage level (disconnect level).

Next, the load control apparatus performs a step (S20) of determining whether the load control message satisfies a preset condition. In a case the load control message satisfies the preset condition, the load control apparatus proceeds to perform a step (S30) of transmitting a load control command to at least one or more load devices A and B (230 and 240) based on the load control message 300.

In a case the load devices A and B (230 and 240) are not equipped with separate load control apparatus, the load control command may be a command controlling a switch of the load device. However, in a case the load devices A and B (230 and 240) are equipped with separate load control apparatus, the load control command may include load control conditions for the load devices to execute.

For example, the load control command may include a device ID configured to identify a particular load device, a start time for starting an event, and duration for indicating an event performance period (duration). Furthermore, the load control command may include and transmit price-based information obtained when the load control command is executed. In this case, the load device may include a display device displaying information included with the price-based information.

Furthermore, the load control command may selectively include information for controlling a connection (ON) time section of the load device, a disconnection (OFF) time section, a repetitive cycle and an operation subsequent to a predetermined time after receipt of the load control message.

Furthermore, the load control command may selectively include a cooling temperature change offset, a cooling temperature set-up point, a heating temperature change offset, a heating temperature set-up value, an average load save rate and compulsory operation rate, where the cooling temperature change offset notifies what degrees of a cooling temperature are to be changed from a currently set temperature, and the cooling temperature set-up value notifies that a cooling temperature is to be set up with this value. The heating temperature change offset and the heating temperature set-up value perform the same function relative to the heating temperature. The average load save rate indicates what percentage of value a currently used load amount relative to an average load amount is controlled, and the compulsory operation rate indicates a value in percentage of a period to be essentially operated in a total of load control period (duration).

Furthermore, the preset load control condition is a condition pre-inputted by a user, and may be a price-based condition. For example, the preset load control condition may be a condition activating the load devices A and B (230 and 240) in a case the price-based information corresponding to price-based information included in the load control message does not surpass a particular value. That is, the load control condition may be a condition of whether to control a load based on a value corresponding to any one of an energy rate included in the load control message and a rate level corresponding to saved rate.

Furthermore, the preset load control condition may be time information for load control. For example, the preset load control condition may be a load control condition where a load control-permitted particular time zone is pre set.

Furthermore, the preset load control condition may be a condition adaptively activating the loads of the load devices 230 and 240 in association with the power tariff or power rate, or a condition adaptively activating the loads of the load devices 230 and 240 in response to consumed accumulated power value. Furthermore, the preset load control condition may include critical level information indicating execution of setup condition other than setup condition.

Hereinafter, a step of determining whether the load control message in the load control apparatus 220 satisfies the preset condition will be described in more detail.

The load control apparatus 220 analyzes critical information indicating urgency of the received load control message 300. In a case the critical information indicating the urgency indicates a low-urgency level, a load control condition inside the load control message to be compared with the preset load control condition is compared with the price-based information. In a case the load control condition inside the load control message or the price-based information is included within a scope of the preset load control condition, it is determined that the preset condition is satisfied, where, in a case the preset load control condition is the price-based information, the price-based information included in the load control message and the price-based information of the preset load control condition are compared.

Meanwhile, in a case the critical information indicating urgency of the received load control message 300 is a critical level indicating urgency, comparison may be made with the critical level information contained in the preset load control condition to selectively determine whether to deactivate the load of the load device. However, in a case the preset load control condition is not contained with the critical level information, a determination is made as to whether to generate a control command for performing the load control based on the received load control message and the state information of the corresponding load device.

In a case the critical information indicating urgency of the received load control message 300 is an outage level indicating an anticipated outage or a forced outage (disconnect) level, a load control is performed in response to the load control message regardless of the preset load control condition.

Meanwhile, in a case the load control message satisfies the preset load control condition, the load control apparatus 220 generates a load control command for performing a load control condition of the load control message with reference to state information of controllable load device. For example, in a case the load control condition of the load control message is a condition to reduce a total load amount to 80%, the load control apparatus generates a command to selectively control the load of at least one load device, based on current state information of a controllable load device and anticipated future state information.

Successively, the load control apparatus 220 transmits to the host device 100 a response message including information indicating load control state in response to the load control message of the host device 100 (or outside device) (S40).

At this time, the response message of S40 may include response contents of other types in response to load control condition of the load control message. For example, the response may be responded in the form of “YES” or “NO”, and may be responded with information indicating execution percentage.

Meanwhile, the load devices A and B (230 and 240) may transmit a load activation request message to the load control apparatus 220 for activation of loads, that is, for connection with a power line. In this case, the load control apparatus may transmit to the load device a response message indicating whether to approve the load activation request message based on the load control message received from the host device and preset load control condition.

Meanwhile, the abovementioned preset load control condition may be a load control condition by a user input set up before receipt of the load control message, or a load control condition changed by a user in response to the load control message after the load control message is received.

Now, description will be made to a case where the preset load control condition is a load control condition changed by a user in response to the load control message after the load control message is received.

In a case the load control apparatus 220 receives a load control message from the host device, the load control device displays on a display device visually recognizable by a user the load control message or information corresponding to the load control message. In a case the user inputs the load control command in response to the displayed load control message or the information corresponding to the load control message, the load control condition preset by the load control command of the user is changed.

At this time, the load control message displayed on the display device may be at least one of the load control condition included in the load control message and price-based information. The load control condition may be rate level corresponding to the energy rate saved during the load control or the rate level corresponding to saved rate.

### INDUSTRIAL APPLICABILITY

In an advantageous aspect, the load control method according to the exemplary embodiments of the present disclosure is such that a user can institutively recognize a gain of load control command to further enhance efficiency of a load control on the load devices 230 and 240, and a user participation to the load control command can be more positively induced by notifying information on load control moneywise in terms of position of utility 110 as a power supplier.

In another advantageous aspect, rate charges to load control can be further eased in terms of position of utility, and in a case a load control command is automatically canceled, a user can recognize the cancellation to allow a user to easily recognize the load control and load state.

Although the present disclosure has been described with reference to a number of illustrative embodiments thereof, it should be understood that numerous other modifications and embodiments can be devised by those skilled in the art that will fall within the spirit and scope of the principles of this disclosure.

1. A load control method for load control apparatus, the method comprising:
receiving, from a host device, a load control message comprising a condition to be performed by load control and price-based information;
determining whether the load control message satisfies a preset condition;
transmitting a load control command to at least one load device based on the load control message when the load control message satisfies the preset load control condition; and
transmitting a response message comprising information indicating load control state to the host device or an outside device in response to the load control message.

2. The method of claim 1, further comprising:
transmitting the load control message to a display device; and
performing a load control of at least one load device in response to the load control command when the load control command is received from a user.

3. The method of claim 2, wherein the display device is included in the load control apparatus or the load device.

4. The method of claim 2, wherein the display device includes a mobile device.

5. The method of claim 1, wherein the price-based information includes information indicating a saved energy rate or a rate level corresponding to saved rate when the load control is performed.

6. The method of claim 1, wherein the preset load control condition comprises at least one of price-based information during load control and time information for load control.

7. The method of claim 1, further comprising:
receiving from the load device a request message for load activation; and
transmitting to the load device a response message indicating whether to approve of the load activation request message based on at least one of the load control message and the preset load control condition.

8. A load control method for load control apparatus, the method comprising:
receiving, from a host device, a load control message including dynamic rate information related to time;
determining whether the load control message satisfies the preset load control condition;
transmitting a load control command to at least one load device based on the load control message when the load control message satisfies the preset load control condition; and
transmitting a response message including information indicating load control state to the host device or an outside device in response to the load control message.

9. The method of claim 8, further comprising:
transmitting the load control message to a display device, and
performing the load control of devices in a consumer house in response to the load control command when the load control message is received from a user.

10. The method of claim 8, wherein the dynamic rate information includes information indicating any one of TOU (Time of Use), CPP (Critical Peak Pricing), CPR (Critical Peak Rebate) and RTP (Real Time Pricing).

11. The method of claim 8, wherein the preset load control condition includes at least one of a save amount during load control and time information for load control.

12. The method of claim 8, further comprising:
receiving, from a device in a consumer house, a request message for load activation; and
transmitting to, the device in the consumer house, a response message indicating whether to approve of the load activation request message based on at least one of the load control message and a user load control condition.
